(19) United States
(12) Patent Application Publication
(10) Pub. No.: US 2006/0050217 A1
(43) Pub. Date: Mar. 9, 2006

(54) Electro-optical device, method of manufacturing the same, and electronic apparatus

(75) Inventors: Hiromi Wano, Suwa-city (JP); Takaaki Tanaka, Matsumoto-shi (JP)

Correspondence Address: OLIFF & BERRIDGE, PLC, P.O. BOX 19928, ALEXANDRIA, VA, 22320, US

(73) Assignee: Seiko Epson Corporation, Tokyo (JP)

(21) Appl. No.: 11/196,679

(22) Filed: Aug. 4, 2005

(30) Foreign Application Priority Data
Sep. 3, 2004 (JP) 2004-256909

(51) Int. Cl. G02F 1/1337

(52) U.S. Cl. 349/124

(57) ABSTRACT

An electro-optical device includes a pair of substrates; electro-optical material that is inserted between the pair of substrates; and an alignment film that is formed on a surface contacting the electro-optical material on at least one substrate of the pair of substrates. In the electro-optical device, the alignment film is formed by laminating a regulation layer and an auxiliary layer on the surface, the regulation layer exerting an alignment regulating force to regulate alignment of the electro-optical material in a particular direction on the surface, and the auxiliary layer provided below the regulation layer and exerting an alignment regulating force in at least an azimuthal direction along the surface of the particular direction to assist the regulation layer for the alignment regulating force of the regulation layer.

### BACKGROUND OF THE INVENTION

1. Technical Field

The present invention relates to an electro-optical device such as a liquid crystal display and the like, to a method of manufacturing the same, and to an electronic apparatus, such as a liquid crystal projector and the like, including the electro-optical device.

2. Related Art

In electro-optical devices, alignment control for electro-optical material is performed by an alignment film having a specific surface shape. Such an alignment film may be fabricated not only by performing a rubbing process on an organic film such as polyimide or the like but also by performing a vacuum deposition process (that is, an oblique deposition process) or a sputtering process on a substrate in an oblique direction with inorganic material such as silicon oxide (SiO) or the like. A film formation method in which such evaporating material is supplied in a direction oblique with respect to a film formation surface is appropriately referred to as ‘oblique film formation method’ hereinafter.

According to the oblique film formation method, a fine columnar structure of evaporated material oblique in an incident direction with respect to a substrate is formed by a self-shadowing effect, and then, liquid crystal is aligned using this columnar structure. The oblique film formation method has attracted considerable attention as a method for overcoming problems in the rubbing process, such as a strip pattern caused in an alignment process, and the difficulty of obtaining an alignment film having excellent light resistance. In addition, it is known that the alignment film formed by the oblique film formation method horizontally or vertically aligns liquid crystal molecules depending on the deposition material, the shape of the film, or liquid crystal material (for example, see M, Lu et al., SID'00 DIGEST, 29.4, 446 (2000)).

However, in most cases, there exist steps due to the thickness of wiring lines, electrodes, light shielding films and the like on a surface of a substrate serving as a base of the alignment film. For that reason, it is not easy to form the alignment film due to a shadow of the steps caused in the oblique film formation, or there may be a region where no film is formed. Such spots on the alignment film cause weakening of the alignment capability and deterioration of the contrast ratio due to light leakage or transmittance reduction. Accordingly, there have been proposed methods for preventing spots on the alignment film and hence on the display. For example, Japanese Unexamined Patent Application Publication No. 2002-277879 discloses an alignment film consisting of two oblique deposition layers. In this case, a first oblique deposition layer has an azimuthal component of a deposition direction different from that in a second oblique deposition layer, thereby allowing the second oblique deposition layer to be deposited even in the shadow of steps, where it is difficult to deposit the first oblique deposition layer. Additionally, a method for preventing a region where deposition is not achieved due to the steps by using the two oblique deposition layers is also disclosed in Japanese Unexamined Patent Application Publication No. 2001-5003 and Japanese Unexamined Patent Application Publication No. 53-60254.

However, since the alignment ability of the alignment film by the oblique film formation method, including the two-layered alignment film disclosed in Japanese Unexamined Patent Application Publication No. 2002-277879, is basically derived from the film structure, the alignment ability may not come up to a level comparable with an organic polyimide alignment film. Particularly, since a rubbing process is not performed, there is a technical problem in that it is difficult to reliably control a polar angle direction and an azimuthal direction simultaneously, and the display or the response speed may be adversely affected.

Specifically, in application of the alignment film formed by the oblique film formation method to a vertical alignment mode, if the alignment film is formed under a condition of a small pre-tilt angle, since an oblique direction of liquid crystal molecules is not specified, disclination occurs in pixels. However, if the pre-tilt angle is increased to some degree to specify the oblique direction of the liquid crystal molecules, there is a problem in that a black level is not displayed sufficiently darkly due to double refraction of the liquid crystal.

In addition, in application of the alignment film formed by the oblique film formation method to a horizontal alignment mode, since the anchoring strength in the azimuthal direction is weak, depending on used material, there is a problem in that disclination occurs due to a transverse electric field, and the desired transmittance is not obtained.

### SUMMARY

An advantage of the invention is that it provides an electro-optical device which is capable of providing a display with high quality and being manufactured with high efficiency, a manufacturing method thereof, and an electronic apparatus including the electro-optical device.

An electro-optical device according to the invention includes a pair of substrates, electro-optical material inserted between the pair of substrates, and an alignment film formed on a surface contacting the electro-optical material on at least one substrate of the pair of substrates. The alignment film is formed by laminating a regulation layer and an auxiliary layer on the surface, the regulation layer exerting an alignment regulating force to regulate alignment of the electro-optical material in a particular direction on the surface, and the auxiliary layer provided below the regulation layer and exerting an alignment regulating force in at least an azimuthal direction along the surface of the particular direction to assist the regulation layer for the alignment regulating force of the regulation layer.

According to the electro-optical device of the invention, gray scales are represented by controlling an alignment state of the electro-optical material such as liquid crystal and an initial alignment of the electro-optical material is regulated by the alignment film.

The alignment film according to the invention has a multi-layered structure including the regulation layer formed on the surface of the substrate and the auxiliary layer formed below the regulation layer. The regulation layer contacts the electro-optical material to directly control directors of the electro-optical material (that is, an average arrangement direction of the electro-optical material) in the vicinity of an interface with the alignment film and has a function (alignment ability) as an alignment film to regulate the alignment of the electro-optical material in a particular direction. Here, ‘particular direction’ is a direction preset as an alignment direction of the electro-optical material and, typically, is three-dimensionally set as a polar angle direction and an azimuthal direction for the substrate surface.

However, a single regulation layer may not provide a sufficient alignment regulating force as described above. Particularly, an insufficient alignment regulating force in the azimuthal direction may be the cause of display defects such as alignment spots or lowering of a response speed. Accordingly, the invention provides the auxiliary layer formed below the regulation layer for reinforcing the alignment regulating force of the regulation layer. More specifically, the auxiliary layer is configured to have the alignment ability for the azimuthal direction of the particular direction.

Generally, this means making the alignment direction of the electro-optical material regulated by the auxiliary layer equal to the alignment direction of the electro-optical material regulated by the regulation layer or aligning them to become equal to each other. Both of the alignment directions are not necessarily equal to each other depending on an optical mode of the electro-optical material. The auxiliary layer may have not only the alignment regulating force in the azimuthal direction but also the alignment regulating force in the polar angle direction. That is, the auxiliary layer serves to assist the regulation layer for control of the alignment in at least an azimuthal direction. In this sense, the auxiliary layer may be the same film as the regulation layer, or may be different in material or structure from the regulation layer if the alignment regulating force is exerted in only the azimuthal direction. In addition, the auxiliary layer may be a single layer or a plurality of layers.

Although the auxiliary layer is provided below the regulation layer, the auxiliary layer can allow the alignment ability to act on the electro-optical material sufficiently through an interaction with the electro-optical material. In addition, since the alignment ability of the auxiliary layer and the regulation layer is derived from their shape, a thickness of each layer when the layers are formed by the oblique deposition or the like is relatively small, for example, 40 nm to 100 nm. For that reason, a distance between the auxiliary layer and the electro-optical material becomes so small as to interact therebetween.

With this configuration, the alignment film according to the invention has the alignment ability not only due to the rubbing process but also due to the structure or shape of the film itself. That is, the alignment film is formed by a deposition method or a sputtering method, with the substrate surface as a base. In addition, the alignment film is made of an organic material such as SiO or the like and may be formed on one or both of the pair of substrates.

Such an alignment reinforces the alignment regulating force in the azimuthal direction as compared to the regulation layer alone and hence further strengthens the alignment force of the electro-optical material in the azimuthal direction. As a result, for example, even when the alignment film is formed under a condition where a pre-tilt angle is small in the vertical alignment mode, since the oblique direction of the liquid crystal molecules is specified, occurrence of disclination can be suppressed or prevented in advance. In addition, since the anchoring strength in the azimuthal direction becomes sufficiently strong in the horizontal alignment mode, occurrence of disclination can be suppressed or prevented in advance. That is, according to the invention, alignment spots or lowering of response speed of the electro-optical material caused by lack of the alignment regulating force of the alignment film can be suppressed or prevented in advance, thereby allowing display with high quality. In addition, the alignment film according to the invention can be formed by a typical film formation method such as the oblique deposition in a state where its function can reliably operate as long as conditions to give the alignment ability in a particular direction can be set.

As described above, in the electro-optical device of the invention, since the alignment film is formed by laminating the regulation and the auxiliary layer and the alignment ability to align the electro-optical material in a particular direction is given to the auxiliary layer, the alignment force of the electro-optical material in the azimuthal direction can be strengthened, thereby allowing display with high quality.

In addition, such an alignment film does not require the rubbing process since it has the alignment ability according to the film structure. Accordingly, display defects, which may be caused by the rubbing process, can be avoided. At the same time, since the alignment film can be completed by only the film formation using the oblique film formation method or the like, an efficient manufacture of the electro-optical device is possible. In addition, if each layer of the alignment film is made of an inorganic material, there is an advantage in that light resistance can be significantly improved as compared to an organic alignment film such as a polyimide film to be subject to the rubbing process.

In one aspect of the electro-optical device of the invention, the auxiliary layer includes a layer to horizontally align the electro-optical material.

According to this aspect, the auxiliary layer is configured to include a layer having only the alignment regulating force in the azimuthal direction. That is, this layer may be a single layer or a plurality of laminated layers.

If the auxiliary layer has the alignment regulating force in the polar angle direction, it is preferable that the alignment regulating force exert in a particular direction in which the regulation layer is to be regulated. Although not so, the alignment regulating force must be set aiming at a preset direction. However, as described above, it is difficult to control the alignment regulating force simultaneously in the polar angle direction and the azimuthal direction. On the other hand, in the auxiliary layer of this aspect, since the alignment regulating force may be given considering only the azimuthal direction for at least one layer, it is possible to relatively simply form the alignment film whose whole alignment regulating force reliably exerts to align the electro-optical material in a proper direction.

In another aspect of the electro-optical device of the invention, a direction of the alignment regulating force of the auxiliary layer is aligned with a direction of the alignment regulating force of the regulation layer in the azimuthal direction.

According to this aspect, the azimuthal direction of the electro-optical material when the electro-optical material is aligned by the auxiliary layer becomes equal to the azimuthal direction of the electro-optical material when the electro-optical material is aligned by the regulation layer. In addition, here, ‘alignment of direction’ not only means that the directions of the alignment regulating forces become completely equal (this setting is difficult to be achieved in reality), but also includes setting errors in the directions of the alignment regulating forces. That is, it is meant that the directions of the alignment regulating forces are substantially aligned. As a result, the alignment film can effectively improve the alignment regulating force in the azimuthal direction.

In yet another aspect of the electro-optical device of the invention, the auxiliary layer is a single layer.

According to this aspect, the alignment film consists of a single auxiliary layer and a single regulation layer. The auxiliary layer can sufficiently exhibit a function of reinforcing the regulation layer although it is a single layer. In addition, in this case, only the single auxiliary layer may be controlled, while, if the auxiliary layer consists of a plurality of layers, the alignment regulating force for each layer and the whole alignment regulating force are required to be controlled.

For that reason, the configuration of the alignment film can be simplified, thereby further improving manufacture efficiency.

In yet another aspect of the electro-optical device of the invention, the regulation layer and the auxiliary layer are formed by supplying the materials thereof to the surface from an oblique direction.

According to this aspect, the alignment film is formed by the film formation method of supplying the material to the substrate surface from the oblique direction (that is, the oblique film formation method). An oblique deposition method is a representative example of such a film formation method. Besides, the film formation method may include, for example, a sputtering method of injecting an evaporation material from the oblique direction. In addition, although not particularly limited if only depositable, an inorganic material is commonly used as the evaporation material.

In this oblique film formation method, the alignment direction of the electro-optical material can be controlled depending on conditions on film formation and the like. For example, when fluoride liquid crystal having negative dielectric anisotropy is used as the electro-optical material in the vertical alignment mode, it is known that a pre-tilt angle of alignment is about 90° if a deposition angle of the alignment film is small (that is, if the alignment film is close to an isotropic film), but the pre-tilt angle becomes increase as the deposition angle becomes increase. In addition, the liquid crystal having the same negative dielectric anisotropy may be horizontally aligned depending on the material of the alignment film. In addition, when fluoride or cyano liquid crystal having positive dielectric anisotropy is used as the electro-optical material, it is known that the pre-tilt angle is varied depending on the deposition angle although the liquid crystal molecules are horizontally aligned.

Accordingly, a desired alignment ability can be given to each of the regulation layer and the auxiliary layer only by properly setting the conditions on film formation.

In yet another aspect of the electro-optical device of the invention, the auxiliary layer includes a layer having a material or a structure different from a material or a structure of the regulation layer.

According to this aspect, since the auxiliary layer is different in material or structure from the regulation, the auxiliary layer can be configured to have an alignment regulating force having a direction or a magnitude different from a direction or a magnitude of the alignment regulating force of the regulation layer. In other word, the alignment regulating force of the alignment film can be designed based on the material or the structure of each layer, and thus, the alignment direction of the electro-optical material can be controlled. Controllability of the alignment direction is remarkable particularly when the alignment film is formed by the oblique film formation method.

In this aspect, preferably, the regulation layer is formed of a silicon oxide film and the auxiliary layer is formed of an aluminum oxide (Al₂O₃) film.

In this case, the alignment film can be configured such that the regulation layer has an alignment regulating force exerting to vertically align the electro-optical material and the auxiliary layer has an alignment regulating force exerting to horizontally align the electro-optical material, and, specifically, is applicable to the vertical alignment mode.

There is no limitation to film formation methods of the aluminum oxide film constituting the auxiliary layer. However, when the aluminum oxide film is formed while supplying the material at an angle of 30° to 70° from a normal direction to the substrate surface particularly using the oblique film formation method, the electro-optical material can be aligned in parallel to the supply direction of aluminum oxide and a relatively strong alignment regulating force in the azimuthal direction can be obtained.

In addition, there is no limitation to film formation methods of the silicon oxide film constituting the regulation layer. However, when the silicon oxide film is formed while supplying the material at an angle of 30° to 70° from a normal direction to the substrate surface particularly using the oblique film formation method, the electro-optical material can be vertically aligned with an oblique angle and a relatively strong alignment regulating force in the polar angle direction can be obtained.

Accordingly, in the alignment film, the regulation layer to directly control the directors of the electro-optical material in the vicinity of an interface of the alignment film mainly exhibits the regulation force exerting to vertically align the electro-optical material and the auxiliary layer assists the regulation force in the azimuthal direction. As a result, a relatively strong alignment regulating force can exert as a whole.

Preferably, each of the regulation layer and the auxiliary layer is formed of a silicon oxide film.

In this case, the alignment film can be configured to have the alignment regulating force exerting to horizontally align the electro-optical material of the regulation film and the auxiliary film, and, specifically, is applicable to the horizontal alignment mode.

The auxiliary layer and regulation layer formed using the silicon oxide can horizontally align the electro-optical material at a pre-tilt angle of 0° to 30° in parallel to or perpendicular to the supply direction of the silicon oxide, and a relatively strong alignment regulating force in the azimuthal direction is obtained.

Accordingly, in the alignment film, the regulation layer to directly control the directors of the electro-optical material in the vicinity of an interface of the alignment film mainly exhibits the regulation force exerting to horizontally align the electro-optical material and the auxiliary layer assists the regulation force. As a result, a relatively strong alignment regulating force can exert as a whole.

An electronic apparatus of the invention includes the above-described electro-optical device (including various configurations) of the invention.

The electronic apparatus of the invention including the above-described electro-optical device of the invention can display images with high quality and can be manufactured with high efficiency. The electronic apparatus can be implemented as various electronic apparatuses including, for example, a projection type display apparatus, a television receiver, a potable telephone, an electronic organizer, a word processor, a view-finder type or monitor-direct view type video tape recorder, a workstation, a television telephone, a POS terminal, a touch panel and the like.

A method of manufacturing an electro-optical device according to the invention including a pair of substrates, electro-optical material inserted between the pair of substrates, and an alignment film formed on a surface of at least one substrate of the pair of substrates facing the electro-optical material. The method includes forming the alignment film by laminating a regulation layer and an auxiliary layer on the surface, the regulation layer exerting an alignment regulating force to regulate alignment of the electro-optical material in a particular direction on the surface, and the auxiliary layer provided below the regulation layer and exerting an alignment regulating force in at least an azimuthal direction along the surface of the particular direction to assist the regulation layer for the alignment regulating force of the regulation layer, and, after forming the alignment film, assembling the pair of substrates and the electro-optical material by opposing one of the pair of substrates to another of the pair of substrates, with the surface serving as an inner side, and by inserting the electro-optical material between the pair of substrates.

According to the manufacturing method of the electro-optical apparatus of the invention, the alignment film according to the invention is formed by forming the regulation and the auxiliary layer on the substrate surface using a deposition process, a sputtering process or the like. In this case, the supply direction of material is properly set in the azimuthal direction and the polar angle direction with respect to the substrate surface.

After forming the alignment film, in assembling the pair of substrates and the electro-optical material, one of the pair of substrates opposes another of the pair of substrates with the surface as an inner side and the electro-optical material is inserted between the pair of substrates. As described above in connection with the electro-optical device, since the formed alignment film has a sufficiently strong alignment regulating force, there occurs little alignment defect in the electro-optical material inserted between the substrates with the electro-optical material contacting the alignment film.

Accordingly, in the electro-optical device manufactured according the above-described manufacturing method, light leak or lowering of a contrast ratio due to alignment defects of the electro-optical material can be suppressed or avoided, thereby allowing display with high quality.

In addition, since the alignment film having the strong alignment regulating force is formed by a normal method except for the setting of conditions in film formation such as the supply direction of the material on the substrate surface, the electro-optical device exhibiting excellent display quality can be manufactured with relative ease, thereby improving manufacture efficiency.

In an aspect of the manufacturing method of the electro-optical device of the invention, in forming the alignment film, the size and exertion direction of each alignment regulating force of the regulation layer and the auxiliary layer are set by adjusting at least one of (i) the kind of the electro-optical material, (ii) a supply angle of the material to the surface of the substrate, and (iii) a supply speed of the material to the surface of the substrate.

According to this aspect, in the regulation layer and the auxiliary layer, the magnitude and exertion direction of the alignment regulating force to be given according to at least one of the above three conditions on film formation are set in advance. Such a setting is possible because the alignment regulating force of the alignment film according to the invention is caused not only by the rubbing process but also by the structure of the alignment film itself. Particularly when the oblique film formation method is used, since the magnitude or exertion direction of the alignment regulating force is greatly varied depending on the conditions on film formation, the alignment regulating force can be controlled by setting the conditions on film formation.

Accordingly, if only the conditions on film formation are precisely set, since the alignment regulating force reliably exerts according to the conditions on film formation set for the alignment film to be formed, the electro-optical device can be manufactured with high efficiency.

In this aspect, preferably, the supply angle is set to be more than 30 degrees and less than 70 degrees with respect to a normal direction of the surface of the substrate in forming the regulation layer and the auxiliary layer.

Results of studies by the inventors of the invention shows that, when the supply angle is set within this range, the alignment film formed at a specific supply angle vertically or horizontally aligns the electro-optical material depending on quality of the film. That is, it is possible to successively form the regulation layer to align the electro-optical material in the vertical alignment mode and the auxiliary layer to align the electro-optical material in the horizontal alignment mode only by making the supply angle constant and supplying different material. Accordingly, the alignment film can be formed more simply, thereby allowing manufacture of the electro-optical device with more efficiency.

In addition, results of studies by the inventors of the invention shows that, when the deposition angle is set within the above-mentioned range, the pre-tilt angle of the liquid crystal aligned by the formed oblique deposition film becomes approximately constant. That is, a margin of the deposition angle becomes significantly large in this range, thereby giving an advantage in manufacturing the electro-optical device.

### BRIEF DESCRIPTION OF THE DRAWINGS

The invention will be described with reference to the accompanying drawings, wherein like numbers reference like elements, and wherein:

FIG. 1 is a plan view of an entire configuration of an electro-optical device according to a first embodiment;

FIG. 2 is a sectional view taken along a line II-II in FIG. 1;

FIG. 3 is a perspective view illustrating a conceptual configuration of an alignment film in the electro-optical device according to the first embodiment;

FIG. 4 is a flow chart of a manufacturing method according to the first embodiment;

FIG. 5 is a sectional view illustrating an outline of a configuration of a deposition apparatus according to the first embodiment;

FIG. 6 is a perspective view illustrating a deposition angle in oblique deposition of an alignment film at a counter substrate side;

FIG. 7 is a graph showing a pre-tilt angle of liquid crystal for the deposition angle of FIG. 6;

FIG. 8 is a perspective view illustrating a conceptual configuration of an alignment film in an electro-optical device according to a second embodiment;

FIG. 9 is a perspective view illustrating a conceptual configuration of an alignment film according to a modification of the embodiments;

FIG. 10 is a perspective view illustrating a conceptual configuration of an alignment film according to another modification of the embodiments;

FIG. 11 is a sectional view illustrating configuration of a liquid crystal projector of an electronic apparatus according to the embodiments of the invention;

FIG. 12 is a table showing conditions on film formation and an evaluation result of an anchoring strength in an azimuthal direction and transmittance in electro-optical devices according to a first example and a first comparative example; and

FIG. 13 is a table showing conditions on film formation and an evaluation result of an anchoring strength in an azimuthal direction and transmittance in electro-optical devices according to a second example and a second comparative example.

### DESCRIPTION OF THE EMBODIMENTS

The above and other operations and advantages of the invention will be more apparent from the following description.

Hereinafter, embodiments of the invention will be described with reference to the accompanying drawings. In the following embodiments, a liquid crystal display will be described as an example of the electro-optical device according to the invention.

### 1: First Embodiment

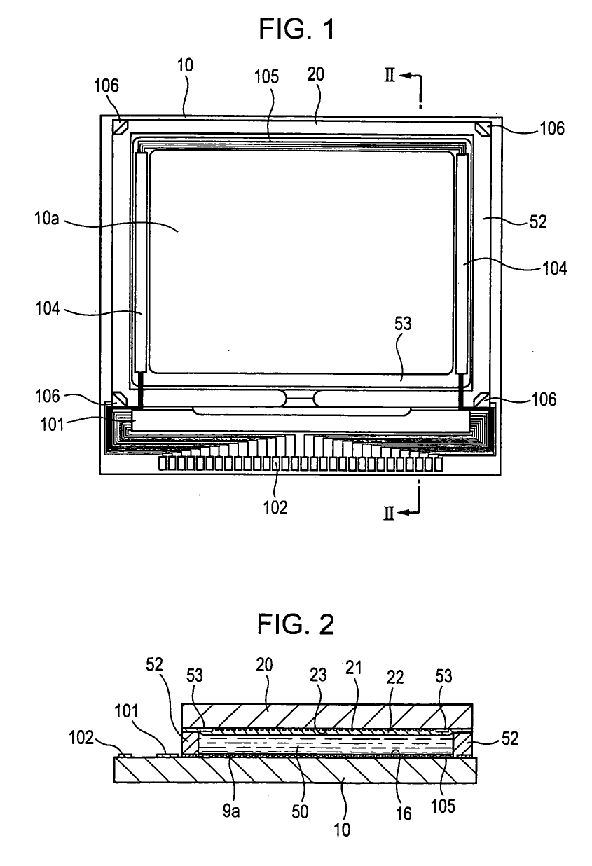

First, a first embodiment of the invention will be described with reference to FIGS. 1 to 6.

1-1: Configuration of Electro-Optical Device

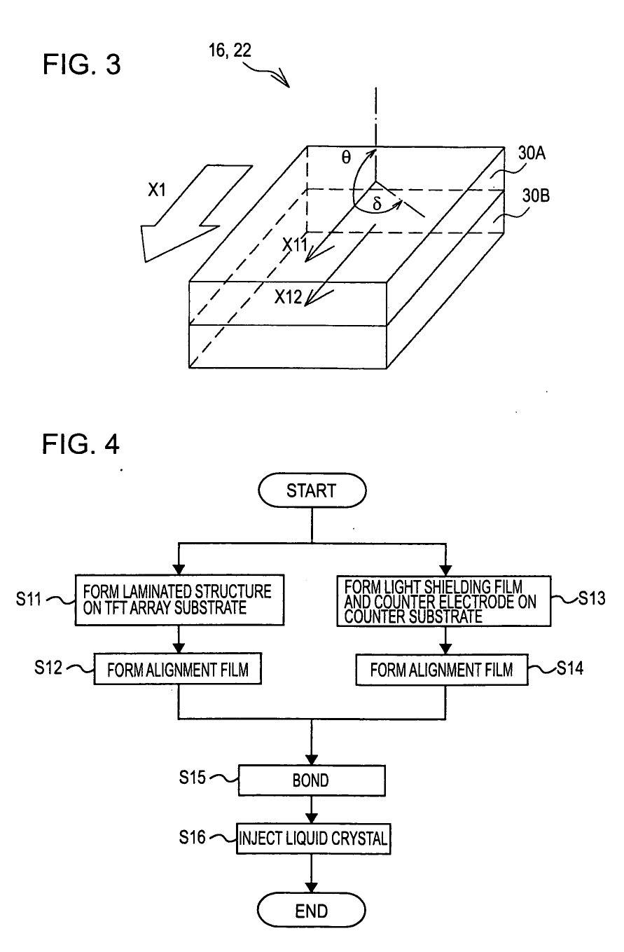

The configuration of an electro-optical device according to this embodiment will be described with reference to FIGS. 1 to 3. FIG. 1 is a plan view of the electro-optical device according to this embodiment when viewed from a counter substrate side. FIG. 2 is a sectional view taken along line II-II in FIG. 1. FIG. 3 illustrates a conceptual configuration of an alignment film formed on a TFT array substrate or a counter substrate. In addition, the electro-optical device employs a built-in driving circuit-type TFT active matrix driving method.

In FIGS. 1 and 2, the electro-optical device is configured by a TFT array substrate 10 and a counter substrate 20 opposite to the substrate 10. A liquid crystal layer 50 is interposed between the TFT array substrate 10 and the counter substrate 20. In addition, the TFT array substrate 10 and the counter substrate 20 are bonded to each other by a sealing agent 52 provided in a sealing region around the circumference of an image display region 10a.

The sealing agent 52 is made of, for example, an ultraviolet-curing resin, a thermosetting resin, or the like for bonding both substrates, coated on the TFT array substrate 10 in a manufacturing process, and then cured by ultraviolet irradiation, heating and the like. In addition, gap material, such as glass fibers or glass beads, is dispersed in the sealing agent 52 such that a space between the TFT array substrate 10 and the counter substrate 20 (a gap between the substrates) has a prescribed value.

At the side of the counter substrate 20 is provided a frame-shaped light shielding film 53 defining a frame region of the image display region 10a in parallel to an inner side of the sealing region in which the sealing agent 52 is arranged. In this case, some or all of the frame-shaped light shielding film 53 may be provided as a built-in light shielding film at the side of the TFT array substrate 10.

In a peripheral region of the image display region 10a at an outer side of the sealing region in which the sealing agent 52 is arranged, a data line driving circuit 101 and external circuit connecting terminals 102 are provided along one side of the TFT array substrate 10. In addition, two scanning line driving circuits 104 are provided along two sides adjacent to the one side, respectively, in such a manner that the scanning line driving circuits 104 are covered with the frame-shaped light shielding film 53. In addition, in order to connect the two scanning line driving circuits 104 to each other, which are provided at both sides of the image display region 10a, respectively, a plurality of wiring lines 105 is provided along one remaining side of the TFT array substrate 10 and is covered with the frame-shaped light shielding film 53.

In addition, at four corners of the counter substrate 20 is provided upper and lower conductive material 106 serving as upper and lower conductive terminals between both substrates. On the other hand, at regions of the TFT array substrate 10 opposite to these corners are provided upper and lower conductive terminals.

Also, in addition to the data line driving circuit 101 and the scanning line driving circuits 104, on the TFT array substrate 10 may be provided a sampling circuit for sampling image signals on image signal lines and supplying the sampled image signals to a plurality of data lines, a pre-charge circuit for supplying pre-charge signals of a prescribed voltage level to the plurality of data lines prior to the image signals, and a check circuit for evaluating the quality, checking for defects, and the like of the electro-optical device during manufacture or at shipping time.

In FIG. 2, pixel electrodes 9a are provided on a wiring line layer including pixel switching TFTS, scanning lines, data lines and the like on the TFT array substrate 10. In addition, an alignment film 16 is formed immediately above the pixel electrodes 9a. On the other hand, a counter electrode 21 is formed on a surface of the counter substrate 20 opposite to the TFT array substrate 10. The counter electrode 21 is composed of a transparent conductive film such as an ITO film, like the pixel electrodes 9a. A strip-shaped light shielding film 23 is formed between the counter substrate 20 and the counter electrode 21 to cover a region opposite to the TFTs in order to prevent light leakage current from occurring in the TFTS. In addition, an alignment film 22 is formed on the counter electrode 21.

The liquid crystal layer 50 is provided between the TFT array substrate 10 and the counter substrate 20 as configured above. The liquid crystal layer 50 is formed by injecting liquid crystal into a space defined by sealing edges of the TFT array substrate 10 and the counter substrate 20 by means of the sealing agent 52. The liquid crystal layer 50 assumes an alignment state by the alignment film 16 and the alignment film 22 under a condition where an electric field is not applied between the pixel electrodes 9a and the counter electrode 21. In addition, in these embodiments, the liquid crystal layer 50 has negative dielectric anisotropy (Δε<0) and consists of liquid crystal driven in a vertical alignment mode.

In FIG. 3, the alignment film 16 and the alignment film 22 are formed by laminating two oblique deposition layers, that is, a regulation layer 30A and an auxiliary layer 30B. In addition, the regulation layer 30A is arranged at the side of the liquid crystal layer 50, and the auxiliary layer 30B is arranged at the side of the TFT array substrate 10. Accordingly, in the alignment film 16 in FIG. 2, the positional relation between the regulation layer 30A and the auxiliary layer 30 becomes the inverse of that shown in FIG. 3.

The regulation layer 30A, which contacts the liquid crystal molecules as the uppermost layer of the alignment film 16 or 22, is a layer for directly regulating directors in the vicinity of an interface between the liquid crystal layer 50 and the alignment film. That is, the regulation layer 30A essentially has alignment ability to regulate the directors of the liquid crystal layer 50 in a particular direction. Here, since the liquid crystal layer 50 is driven in the vertical alignment mode, the regulation layer 30A functions as an alignment film for vertically aligning the liquid crystal molecules and has an alignment regulating force of a polar angle direction θ and an alignment regulating force X11 of an azimuthal direction δ with respect to a surface of the substrate.

The auxiliary layer 30B is provided under the regulation layer 30A and has alignment ability to reinforce the alignment regulating force of the regulation layer 30A. Specifically, the auxiliary layer 30B functions as an alignment film for horizontally aligning the liquid crystal molecules and has an alignment regulating force X12 in a direction aligned with the alignment regulating force X1 of the azimuthal direction δ. For this reason, the overall alignment ability of the alignment films 16 and 22 is reinforced in the azimuthal direction δ.

The regulation layer 30A and the auxiliary layer 30B are formed by the oblique deposition and have a thickness of about 40 nm to 100 nm (400 Å to 1000 Å), for example. That is, the regulation layer 30A and the auxiliary layer 30B are roughly formed as monomolecular films. In addition, while these layers are preferably composed of an inorganic film since inorganic material is commonly used as evaporation material for these layers, organic material may be used if depositable. However, it is considered that the inorganic film is generally preferable to improve the light resistance. As the composition of each layer, the regulation layer 30A may employ one of SiO₂, SiO, MgF₂, MgO, TiO₂ and the like, for example. The auxiliary layer 30B may employ Al₂O₃ and the like, for example, in addition to the same composition as the regulation layer 30A.

The oblique deposition film is formed in a columnar shape by obliquely being deposited and aligns the liquid crystal by the effect of this columnar shape. For this reason, while the alignment ability may be insufficient with a single regulation layer 30A, for example, the alignment ability of the azimuthal direction 6 is reinforced by the auxiliary layer 30B provided under the regulation layer 30A in the alignment films 16 and 22 of this embodiment. As a result, the alignment films 16 and 22 can increase the alignment regulating force in the azimuthal direction δ by exerting a sufficiently large alignment regulating force X1 in the azimuthal direction δ and reinforcing the anchoring strength of the liquid crystal molecules of the liquid crystal layer 50 in the azimuthal direction δ.

Accordingly, the electro-optical device of this embodiment can suppress the occurrence of alignment spots of the liquid crystal in the liquid crystal layer 50 and lowering of the response speed when the electro-optical device is driven, thereby allowing superior display operation to be realized.

1-2: Manufacturing Method of Electro-Optical Device

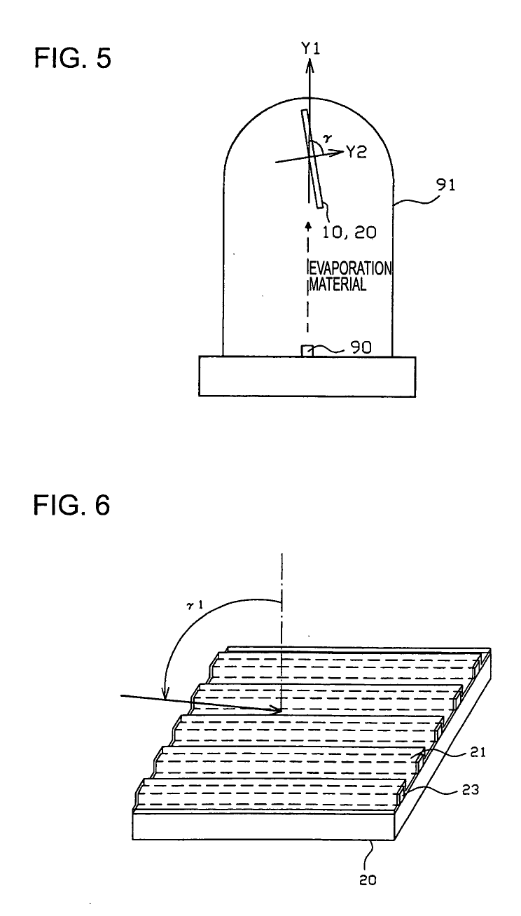

Next, a manufacturing method of the above-described electro-optical device will be described with reference to FIGS. 4 to 6. FIG. 4 is a flow chart showing manufacturing processes of the electro-optical device, FIG. 5 illustrates a configuration of a deposition apparatus used for formation of the alignment films, and FIG. 6 illustrates a deposition angle when the alignment film 22 is deposited on the counter substrate 20.

In the flow chart of FIG. 4, first, a laminating structure is formed on the TFT array substrate 10 (Step S11). This step may be performed, for example, as follows. First, a glass substrate or a quartz substrate is prepared as the TFT array substrate 10, and then, the scanning lines made of metal such as Ti, Cr, W, Ta, Mo, Pd, or the like, or a metal alloy film such as a metal silicide are formed in a pattern on the TFT array substrate 10 by a sputtering process, a photolithography process and an etching process. In addition, a lower insulating film made of NSG or the like is formed on the scanning lines by, for example, an atmospheric pressure CVD method, a low pressure CVD method or the like.

Next, a polysilicon film is formed on a lower insulating film, and then a semiconductor layer is formed in a predetermined pattern by performing a photolithography process and an etching process on the polysilicon film. A surface of the semiconductor layer is thermally oxidized to form a gate insulating film, and then, a gate electrode is formed by a photolithography process and an etching process. In addition, pixel switching TFTs are formed by forming source regions and drain regions in the semiconductor layers by doping impurity ions into the semiconductor layer using the gate electrode as a mask.

Next, a first interlayer insulating film consisting of an NSG film is formed on the TFTs, a lower electrode is formed by thermally diffusing phosphorus (P) into the polysilicon film, and then, a storage capacitor is formed by laminating a dielectric film consisting of a high temperature silicon oxide (HTO) film or a silicon nitride film and capacitive electrodes each consisting of a conductive polysilicon film.

Next, a second interlayer insulating film consisting of an NSG film is formed, and then, the data lines and the like are formed. Next, a third interlayer insulating film is formed, and then, the top surface of the third interlayer insulating film is planarized by a CMP process. Specifically, for example, the top surface of the third interlayer insulating film is polished by making a rotating contact of a surface of the substrate fixed by means of a spindle with a polishing pad fixed on a polishing plate while flowing liquid slurry (chemical polishing fluid) containing silica particles onto the polishing pad.

Next, an ITO film is deposited on the third interlayer insulating film by a sputtering process or the like, and then, the pixel electrodes 9a are formed by performing a photolithography process and an etching process on the ITO film.

In addition, oblique deposition is performed on the entire surface of the TFT array substrate 10, and then, the alignment film 16 consisting of two lamination layers is formed (Step S12).

A deposition apparatus employed for the above-described processes is configured as shown in FIG. 5, for example. This apparatus is a vacuum deposition apparatus including an evaporation source 90 and a bell jar 91 for hermetically sealing the internal configuration to support the deposition substrate at a prescribed angle γ. That is, the TFT array substrate 10 is arranged such that a center axis Y2 of the substrate 10 is inclined at an angle γ (0°<γ<90°) with respect to an axis Y1 indicating a straight direction from the evaporation source 90. At this time, a surface of the TFT array substrate 10 is inclined by the angle γ from the traveling direction of the evaporation material. As a result, material deposited on the TFT array substrate 10 is grown such that a columnar crystal is arranged at a prescribed angle. The alignment film 16 consisting of the oblique deposition film thus obtained can align the liquid crystal molecules of the liquid crystal layer 50 by the effect of the surface shape. In addition, the regulation layer 30A and the auxiliary layer 30B in the alignment film 16 are formed by the same process as in the alignment film 22, which will be described together later.

In parallel with, before, or after the above-described formation process of the structure on the TFT array substrate 10, a process of forming a structure on the counter substrate 20 is performed. That is, a glass substrate or the like is first prepared as the counter substrate 20, and then, a strip-shaped light shielding film 23 is formed by sputtering, for example, chromium or the like on the entire surface of the glass substrate and performing a photolithography process and an etching process thereon. Subsequently, the counter electrode 21 is formed by depositing an ITO film at a thickness of about 50-200 nm using a sputtering process (Step S13).

Next, oblique deposition is performed on the entire surface of the counter substrate 20, and then, the alignment film 22 consisting of two lamination layers is formed (Step S14). In this embodiment, the formation processes of the alignment film 16 and the alignment film 22 correspond to an example of ‘the formation process of the alignment film’ of the invention. Hereinafter, the formation process of the alignment film 22 will be described in detail, but the alignment film 16 may be also formed in the same manner as described above.

The alignment film 22 is formed by sequentially forming the auxiliary layer 30B and the regulation layer 30A on the counter substrate 20 in this order. At this time, the film formation process is performed with a deposition angle γ1 shown in FIG. 6. The deposition angle 71 corresponds to the angle γ shown in FIG. 5, and there exists a correspondence relationship among the deposition angle γ1, the film formation material, and a pre-tilt angle of the liquid crystal in the liquid crystal layer 50. In addition, although the auxiliary layer 30B and the regulation layer 30A are herein formed with the deposition angle γ1, they may be formed with a different deposition angle.

First, for example, an Al₂O₃ film is formed as the auxiliary layer 30B. In this case, the deposition angle γ1 may not be particularly problematic herein: however, it is preferable that the deposition angle γ1 fall within a range of 30° to 70° such that the auxiliary layer 30B can align the liquid crystal in parallel to this deposition direction γ1 and, hence, the alignment film 22 can obtain a relatively strong alignment regulating force in the azimuthal direction δ. More preferably, the deposition direction γ1 falls within a range of 40° to 60°.

Subsequently, for example, a SiO₂ film is formed as the regulation layer 30A on the auxiliary layer 30B. In this case, the deposition angle γ1 may be any angle other than 0° and 90°. If the deposition angle γ1 is 0° or 90°, the film quality of the SiO₂ film is isotropic and compact with no self-shadowing effect, which results in difficulty in exerting the alignment regulating force. In addition, in this case, if the deposition angle γ1 falls within the range of 30° to 70°, it is preferable that the regulation layer 30A vertically align the liquid crystal under a condition where the liquid crystal is tilted, and the alignment film 22 can obtain a relatively strong alignment regulating force in the polar angle direction θ.

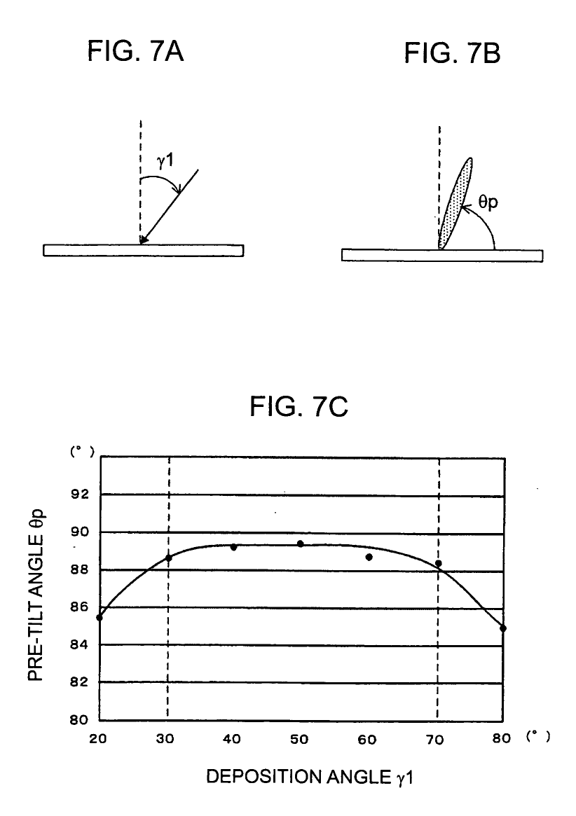

In addition, as shown in FIG. 7, as a result of studies by the inventors of the invention, it has been found that the pre-tilt angle of the liquid crystal aligned by the formed oblique deposition film becomes approximately constant if the deposition angle γ1 falls within a range of 30° to 70°. That is, it is advantageous in terms of manufacturing since the tolerance of the deposition angle γ1 becomes substantially large within this range.

In the above-described film formation processes, it is preferable that the auxiliary layer 30B and the regulation layer 30A be formed such that a direction of the alignment regulating force X12 of the auxiliary layer 30B is aligned with a direction of the alignment regulating force X11 of the regulation layer 30A in the azimuthal direction δ (see FIG. 3). The directions of the alignment regulating forces X11 and X12 may be set depending on deposition conditions such as the deposition material, the deposition angle γ1 and the like.

Thereafter, the TFT array substrate 10 and the counter substrate 20 having the lamination structure as described above is opposite to each other such that the alignment films 16 and 22 face each other, and then, are bonded to each other by the sealing agent 52 (Step S15).

Next, liquid crystal material having negative dielectric anisotropy is injected into a space defined between both substrates, and then, the liquid crystal layer 50 having a prescribed thickness is formed (Step S16). In addition, the bonding process and the liquid crystal injection process correspond to an example of ‘an assembly process’ of the invention.

Since the electro-optical device thus manufactured has the alignment films 16 and 22 with the structure described above, deterioration of display quality due to defects of alignment of the liquid crystal in the liquid crystal layer 50 can be suppressed or alleviated, thereby allowing superior display operation.

That is, the liquid crystal layer 50 is vertically aligned at a prescribed pre-tilt angle by an effect of the surface shape of the alignment films 16 and 22 (particularly, the regulation layers 30A). In addition, since the alignment films 16 and 22 exert the alignment regulating force of the azimuthal direction δ reinforced by the auxiliary layer 30B, the liquid crystal molecules in the liquid crystal layer 50 can be stably aligned in a direction regulated in the azimuthal direction δ when the liquid crystal molecules are horizontally aligned.

For example, it is known that the obliquely deposited SiO₂ film (that is, the same single layer as the regulation film 30A) has a fine columnar structure inclined in the deposition direction γ1 by the self-shadowing effect when the SiO₂ film is formed, and the liquid crystal composed of, for example, fluoride material having negative dielectric anisotropy is aligned along a tilted axis on the SiO₂ film. However, while such a film has a sufficient alignment regulating force in the polar angle direction θ to determine the tilt angle, the alignment regulating force in the azimuthal direction δ (corresponding to the alignment regulating force X11) is weak. It is considered that this is because the oblique deposition film aligns the liquid crystal molecules by the effect of the surface shape resulting from the columnar structure.

When this film is used as an alignment film in the electro-optical device driven in the vertical alignment mode, since the alignment regulating force in the azimuthal direction δ is weak, there arises a problem in that this film is susceptible to a transverse electric field upon application of a voltage for horizontal alignment. That is, the alignment in the azimuthal direction δ is varied by the transverse electric field, which may lead to display defects such as deviation of the viewing angle, reduction of transmittance, or the like. In addition, since the alignment in the azimuthal direction δ is not fixed, it is difficult to design viewing angle compensation using a viewing angle compensation film such as a c-plate or a WV film. In addition, since the axis is deviated, it is impossible to achieve sufficient viewing compensation.

On the other hand, when the Al₂O₃ film (that is, the same single film as the auxiliary layer 30B) is used as the alignment film, even if the Al₂O₃ film is formed at any deposition angle γ1, the liquid crystal having negative dielectric anisotropy is horizontally aligned on the formed alignment film. The results of experiments by the inventors of the invention show that the alignment direction of the liquid crystal molecules is parallel to the deposition direction γ1 and a strong alignment regulating force in the azimuthal direction is obtained, particularly if the deposition angle γ1 falls within the range of 40° to 60°.

Therefore, when the Al₂O₃ film is formed as a layer which does not make direct contact with the liquid crystal layer 50 and the SiO₂ film is formed as the alignment film on the Al₂O₃ film by the oblique deposition, the alignment regulating force in the polar angle direction θ is maintained by the alignment regulating force of the SiO₂ film contacting the liquid crystal, and the alignment regulating force in the azimuthal direction δ is reinforced by the alignment regulating force of the Al₂O₃ film in the vertical alignment mode. These laminated films are a concrete example of the alignment films 16 and 22 in this embodiment. With such a configuration, a sufficiently strong alignment regulating force is obtained not only in the polar angle direction θ but also in the azimuthal direction δ. For that reason, when the electro-optical device is driven in the vertical alignment mode, display defects due to the transverse electric field can be suppressed, thereby allowing relatively easy and reliable viewing angle compensation. That is, an oblique deposition film, which has stable liquid crystal alignment equal to that of a polyimide film subjected to a rubbing process, can be obtained.

Since the alignment films 16 and 22 are configured by the lamination of the regulation layer 30A and the auxiliary layer 30B in this embodiment, display with high quality is possible due to the strong alignment regulating force.

In addition, since the alignment films 16 and 22 are oblique deposition films and do not require a rubbing process, display defects, which may be caused by the rubbing process, can be avoided. At the same time, since the alignment films 16 and 22 are completed as the alignment film simply by forming them, efficient manufacturing of the electro-optical device is possible. In addition, when the alignment films 16 and 22 are formed by deposition of inorganic material, they have excellent light resistance and heat resistance, and hence, contribute to improvement of durability of the electro-optical device as a light valve. In addition, the alignment films 16 and 22 can control the alignment ability with relative ease and high reliability depending on the film formation conditions such as the evaporation material, the deposition direction γ1, and the like.

### 2: Second Embodiment

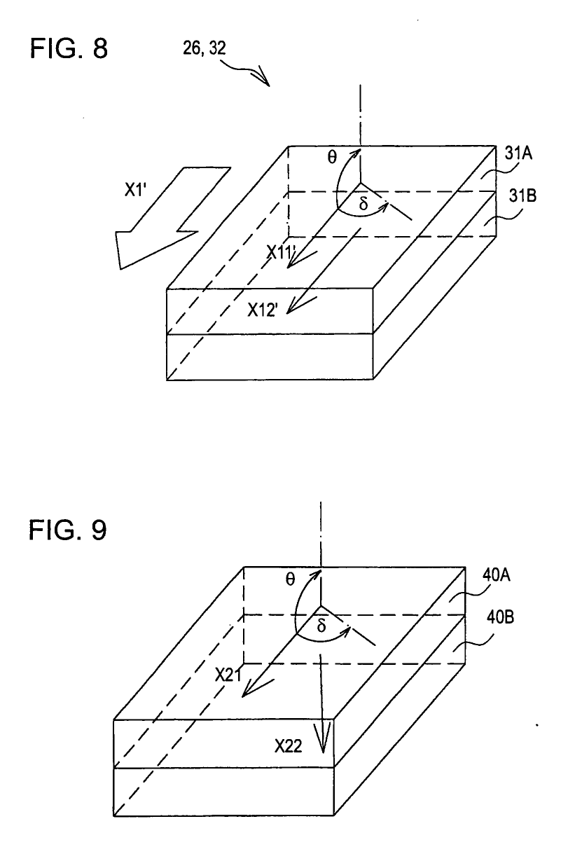

Next, a second embodiment will be described with reference to FIG. 8. FIG. 8 illustrates a conceptual configuration of an alignment film formed on the TFT array substrate or the counter substrate.

The electro-optical device of this embodiment is driven in a horizontal alignment mode unlike the first embodiment employed the vertical alignment mode. For that reason, the second embodiment has the same configuration as the first embodiment except the configuration of the alignment film. Accordingly, in the second embodiment, the same elements as the first embodiment are denoted by the same reference numerals, and explanation thereof will be appropriately omitted.

In this embodiment, fluoride or cyano liquid crystal having positive dielectric anisotropy (Δε>0) is used as the liquid crystal constituting the liquid crystal layer 50. In addition, an alignment film 26 on the TFT array substrate 10 and an alignment film 32 on the counter substrate 20 are all configured to horizontally align the liquid crystal.

In FIG. 8, the alignment films 26 and 32 consist of a regulation layer 31A having the alignment ability to horizontally align the liquid crystal and an auxiliary layer 31B provided below the regulation layer 31A and having the alignment ability to horizontally align the liquid crystal. The regulation layer 31A and the auxiliary layer 31B can be made of the same material as the regulation layer 30A and the auxiliary layer 30B, for example, SiO₂ or the like. However, a deposition direction in formation of these films is appropriately set depending on their respective alignment ability.

For example, since an oblique deposition film applied to the horizontal alignment mode (that is, the same single layer as the regulation film 31A) has a weak alignment regulating force in the azimuthal direction 6 (corresponding to the alignment regulating force X11), there may arise a problem in that this film is susceptible to a transverse electric field upon application of a voltage, thereby causing any display defects such as deviation of a viewing angle, reduction of transmittance or the like. In addition, as in the vertical alignment mode, since the alignment in the azimuthal direction is not fixed, it is difficult to design a viewing angle compensation using a viewing angle compensation film such as a c-plate or a WV film. In addition, since an axis is deviated, it is impossible to achieve a sufficient viewing compensation.

Therefore, in this embodiment, by forming an alignment film to horizontally align the liquid crystal, that is, the auxiliary layer 31B, below the regulation layer 31A, the regulation force in the azimuthal direction δ is reinforced, and accordingly, the whole alignment regulating force of the alignment films 26 and 32 in the azimuthal direction δ is strengthened.

Accordingly, this embodiment achieves the same effect as the first embodiment.

3: Modification of Alignment Film

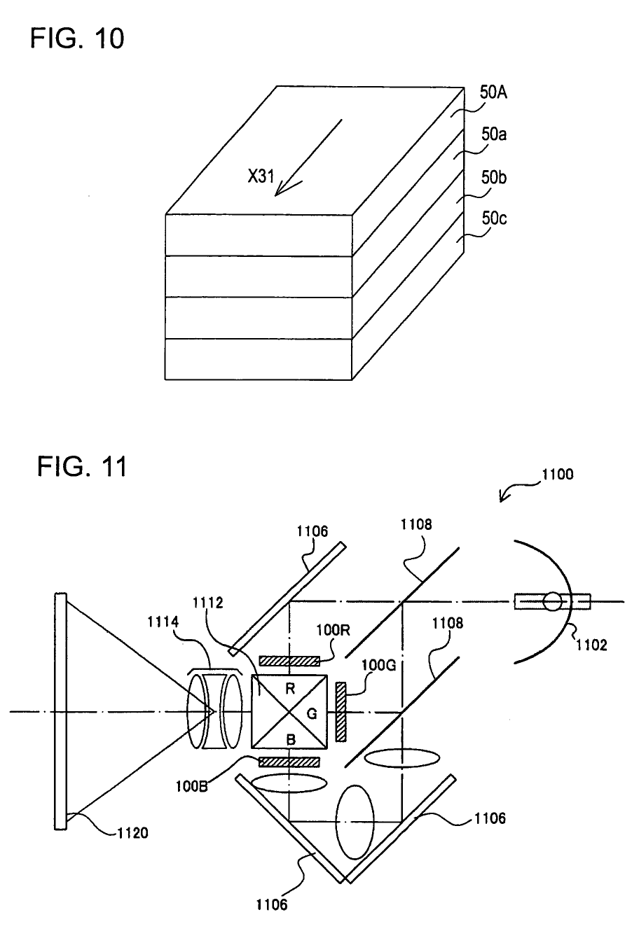

Next, a modification of the alignment films of the first and second embodiments will be described with respect to FIGS. 9 and 10.

For example, although it has been described in the above embodiments that the auxiliary layer has only the alignment regulating force in the azimuthal direction δ to horizontally align the liquid crystal molecules, the auxiliary layer may have an alignment regulating force in the polar angle direction θ.

In addition, although it has been described in the above embodiments that the auxiliary layer and the regulation layer are formed by different material or at different deposition angles, in other words, have different configurations, the auxiliary layer may be the same layer as the regulation layer in the invention. In this case, when these layers are laminated with a thickness close to that of a monomolecular film, the alignment ability for each layer can take effect to regulate the liquid crystal alignment on the whole, as described above. In addition, as the oblique deposition film consisting of a single layer having a thickness corresponding to two layers is varied in its structure depending on its film thickness, such an effect to regulate the liquid crystal alignment may not be expected.

In addition, although it has been described in the above embodiments that the alignment regulating force of the auxiliary layer in the azimuthal direction is equal to the alignment regulating force of the regulation layer in the azimuthal direction, both forces may be set in different directions depending on an optical mode of the liquid crystal. That is, as shown in FIG. 9, an alignment regulating force X22 of an auxiliary layer 40B in the azimuthal direction may be set in a direction different from a direction of an alignment regulating force X21 of a regulation layer 40A in the azimuthal direction. Even in this case, the auxiliary layer serves to assist the regulation layer by providing an alignment regulating force, which could not be obtained by a single regulation layer.

In this way, the regulation layer and the auxiliary layer according to the invention include not only a case of deviation of the direction of the alignment regulating force in the azimuthal direction as manufacture errors when the alignment regulating forces in the azimuthal direction are aligned, but also a case of intentionally making directions of the alignment regulating forces in the azimuthal direction different. That is, the auxiliary layer of the invention aligns the liquid crystal in a direction in which the liquid crystal is desired to be stable in the azimuthal direction, and simultaneously stabilizes and maintains the alignment regulating force in the azimuthal direction.

In addition, although it has been explained in the above description that each of the regulation layer and the auxiliary layer is a single layer, in the alignment film of the invention, two or more auxiliary layer may exist. In an example shown in FIG. 10, three auxiliary layers 42a to 42c are provided for a regulation layer 41A. In this case, the auxiliary layers 42a to 42c may have different material or different deposition conditions, or may have the same configuration. In addition, the alignment regulating forces of these auxiliary layers 42a to 42c in the azimuthal direction δ are preferable to be aligned in direction with, but may be different in direction from the alignment regulating force X31 of the regulation layer 36 in the azimuthal direction δ.

In addition, although it has been described in the above embodiments that the alignment film is the oblique deposition film, an alignment film having the same configuration can be also obtained by a film formation process such as a sputtering process, which is capable of supplying evaporation material in an oblique direction.

4: Electronic Apparatus

The above-described liquid crystal display can be applied to a projector, for example. Here, as an example of the electronic apparatus of the invention, a projector to which the electro-optical device according to the above-mentioned embodiments is applied as a light valve will be described. FIG. 11 illustrates an exemplary configuration of the projector. As shown in FIG. 11, a lamp unit 1102 consisting of a white light source such as a halogen lamp is provided inside a projector 1100. Projected light emitted from the lamp unit 1102 is divided into light components corresponding to three primary colors of red (R), green (G) and blue (B) by four mirrors 1106 and two dichroic mirrors 1108, which are arranged within a light guide. The light components are incident to electro-optical devices 100R, 100B and 100G as light valves corresponding to the primary colors, respectively. Here, the electro-optical devices 100R, 100G and 100B have the same configuration as the above-described electro-optical device and modulate the RGB primary color signals, respectively, which are supplied from an image signal process circuit. The light components modulated by the electro-optical devices 100R, 100G and 100B are incident into a dichroic prism 1112 in three directions. In the dichroic prism 1112, the red (R) and blue (B) light components are refracted by 90 degrees, while the green (G) light component goes straight. Accordingly, images having respective colors are combined, and then, a color image is projected onto a screen 1120 through a projection lens 1114.

In addition, the electro-optical device in the above embodiments may be applied to a direct-view type or reflection type color display apparatus, in addition to the projector. In this case, RGB color filters along with their protective films may be formed in a region opposite to the pixel electrodes 9a on the counter substrate 20. Alternatively, color filter layers may be formed by color resist or the like below the pixel electrodes 9a opposite to RGB on the TFT array substrate 10. In addition, in each of the above cases, when micro-lenses corresponding to pixels in a one-to-one way are arranged on the counter substrate 20, light-collecting efficiency of incident light is improved, which contributes to improvement of display brightness. In addition, by depositing several interference layers having different refractive indexes on the counter substrate 20, dichroic filters to produce RGB colors using light interference may be formed. The counter substrate having these dichroic filters allows brighter display.

### EXAMPLES

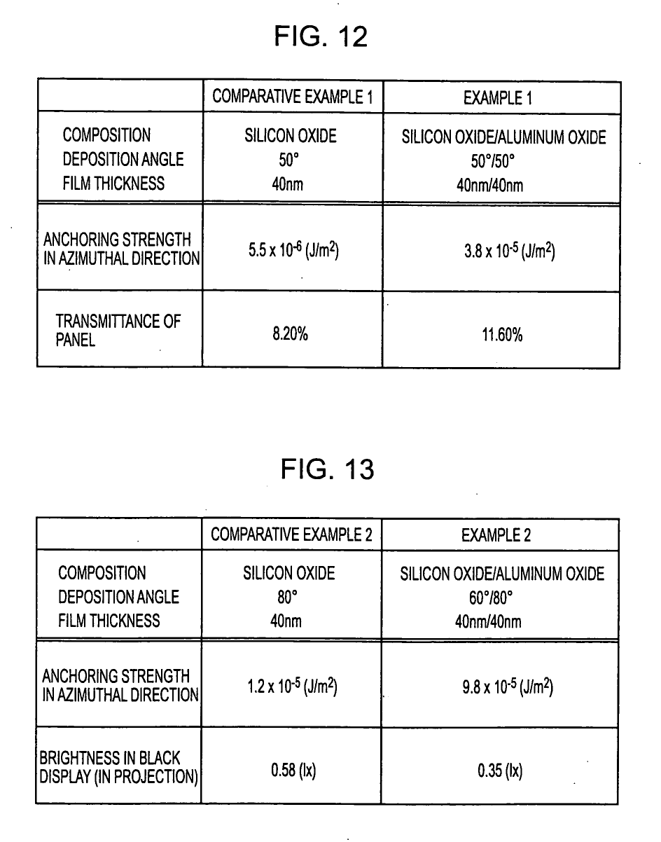

Next, examples of the invention will be described with reference to FIGS. 12 and 13.

### Example 1

As in the first embodiment, an electro-optical device of the vertical alignment mode using the liquid crystal having negative dielectric anisotropy was manufactured. Alignment films of the TFT array substrate and the counter substrate were formed by first forming an Al₂O₃ film as an auxiliary layer and then forming a SiO₂ film as a regulation layer on the auxiliary layer. At that time, according to the manufacture processes of the first embodiment, both regulation layer and the auxiliary layer were subject to oblique deposition at a deposition angle of 50° and had a film thickness of 40 nm (400 Å).

On the other hand, in a first comparative example as a comparative example of the first example, an electro-optical device in which the alignment film consists of a single SiO₂ layer was manufactured. Film formation conditions at this time were the same as those for the regulation layer in the first example. Then, after the electro-optical devices of the first example and the first comparative example were actually driven, the anchoring strength of the liquid crystal in the azimuthal direction and transmittance in an image display region were measured.

FIG. 12 shows the results of measurement of the anchoring strength in the azimuthal direction and the transmittance. From the results shown, it can be confirmed that the first example shows a stronger anchoring strength in the azimuthal direction and higher transmittance than those in the first comparative example. Specifically, since the electro-optical device of the first example exerts a stronger anchoring strength in the azimuthal direction than that of the first comparative example, the electro-optical device of the first example is not susceptible to a transverse electric field, and, as a result, shows improve a transmittance over that of the first comparative example.

### Example 2

In the second embodiment, an electro-optical device of the horizontal alignment mode using the liquid crystal having the positive dielectric anisotropy was manufactured. Alignment films of the TFT array substrate and the counter substrate were formed by first forming a SiO₂ film as an auxiliary layer by performing an oblique deposition at a deposition angle of 80°, and then by forming a SiO₂ film as a regulation layer on the auxiliary layer by performing an oblique deposition at a deposition angle of 60°. At that time, according to the manufacture processes of the first embodiment, both of the regulation layer and the auxiliary layer had a film thickness of 40 nm (400 Å).

On the other hand, in a second comparative example as a comparative example of the second example, an electro-optical device in which the alignment film consists of a single SiO₂ layer was manufactured. Film formation conditions at this time were equal to those for the auxiliary layer in the second example. Then, after the electro-optical devices of the second example and the second comparative example were actually driven, an anchoring strength of the liquid crystal in an azimuthal direction and projection brightness in display of a black color in an image display region were measured.

FIG. 13 shows a result of measurement of the anchoring strength in the azimuthal direction and the brightness of the display of the black color. From the shown result, it can be confirmed that the second example shows a stronger anchoring strength in the azimuthal direction and lower brightness of display of the black color than those in the second comparative example. Specifically, since the electro-optical device of the second example exerts a stronger anchoring strength in the azimuthal direction than that of the second comparative example, the electro-optical device of the second example is not susceptible to a transverse electric field, and, as a result, the liquid crystal alignment in display of the black color is not disordered and hence the brightness of display of the black color is suppressed.

The invention is not limited to the above-described embodiments and examples, but may be changed, modified or altered in various ways without deviating from the gist or spirit of the invention when read throughout the annexed claims and the above description. It is to be understood that electro-optical devices, manufacturing methods thereof, and electronic apparatuses using the electro-optical devices according to such changes, modifications or alterations are included in the scope of the invention. For example, although a transmission type liquid crystal display has been exemplified in the above embodiments, the invention is not limited to this, but may be applied to a reflection type liquid crystal display. In addition, the invention is applicable to other electro-optical devices in which display or the like may be adversely affected by lack of an alignment regulating force of electro-optical material. Such electro-optical devices may include, for example, organic EL devices, electrophoresis devices such as electronic paper and the like.

What is claimed is:

1. An electro-optical device comprising:
a pair of substrates;
electro-optical material that is inserted between the pair of substrates; and
an alignment film that is formed on a surface facing the electro-optical material on at least one substrate of the pair of substrates,
wherein the alignment film is formed by laminating a regulation layer and an auxiliary layer on the surface, the regulation layer exerting an alignment regulating force to regulate alignment of the electro-optical material in a particular direction on the surface, and the auxiliary layer provided below the regulation layer and exerting an alignment regulating force in at least an azimuthal direction along the surface of the particular direction to assist the regulation layer for the alignment regulating force of the regulation layer.

2. The electro-optical device according to claim 1,
wherein the auxiliary layer includes a layer to horizontally align the electro-optical material.

3. The electro-optical device according to claim 1,
wherein a direction of the alignment regulating force of the auxiliary layer is aligned with a direction of the alignment regulating force of the regulation layer in the azimuthal direction.

4. The electro-optical device according to claim 1,
wherein the auxiliary layer is a single layer.

5. The electro-optical device according to claim 1,
wherein the regulation layer and the auxiliary layer are formed by supplying the materials thereof to the surface from an oblique direction.

6. The electro-optical device according to claim 1,
wherein the auxiliary layer includes a layer having a material or a structure different from a material or a structure of the regulation layer.

7. The electro-optical device according to claim 6,
wherein the regulation layer is formed of a silicon oxide film and the auxiliary layer is formed of an aluminum oxide film.

8. The electro-optical device according to claim 6,
wherein each of the regulation layer and the auxiliary layer is formed of a silicon oxide film.

9. An electronic apparatus comprising the electro-optical device according to claim 1.

10. A method of manufacturing an electro-optical device including a pair of substrates, electro-optical material inserted between the pair of substrates, and an alignment film formed on a surface of at least one substrate of the pair of substrates facing the electro-optical material, the method comprising:
forming the alignment film by laminating a regulation layer and an auxiliary layer on the surface, the regulation layer exerting an alignment regulating force to regulate alignment of the electro-optical material in a particular direction on the surface, and the auxiliary layer provided below the regulation layer and exerting an alignment regulating force in at least an azimuthal direction along the surface of the particular direction to assist the regulation layer for the alignment regulating force of the regulation layer; and
after forming the alignment film, assembling the pair of substrates and the electro-optical material by opposing one of the pair of substrates to another of the pair of substrates, with the surface serving as an inner side, and inserting the electro-optical material between the pair of substrates.

11. The method of manufacturing an electro-optical device according to claim 10,
wherein, in forming the alignment film, the size and exertion direction of each alignment regulating force of the regulation layer and the auxiliary layer are set by adjusting at least one of (i) the kind of the electro-optical material, (ii) a supply angle of the material to the surface of the substrate, and (iii) a supply speed of the material to the surface of the substrate.

12. The method of manufacturing an electro-optical device according to claim 11,
wherein the supply angle is set to be more than 30 degrees and less than 70 degrees with respect to a normal direction of the surface of the substrate in forming the regulation layer and the auxiliary layer.
